(19) United States
(12) Patent Application Publication
(10) Pub. No.: US 2016/0117055 A1
(43) Pub. Date: Apr. 28, 2016

(54) FLEXIBLE IMAGE INPUT/OUTPUT DEVICE

(71) Applicant: Ossong International Co., Ltd., Hsinchu City (TW)

(72) Inventors: CHANG-YO HSUAN, Hsinchu City (TW); HSIN-KUO HO, Hsinchu City (TW)

(21) Appl. No.: 14/521,841

(22) Filed: Oct. 23, 2014

(51) Int. Cl. G06F 3/042

(52) U.S. Cl. CPC G06F 3/0425; G06F 2203/04102

(57) ABSTRACT

Disclosure is a flexible image input/output device comprising a first body, a second body and a flexible member. The first body has an image capture module generating a first image signal. The second body separates from the first body and has an image display module receiving the first image signal and displaying a first image. The flexible member, of which one end connects to the first body and another end connects to the second body to transmit the first image signal from the image capture module to the image display module.

### BACKGROUND OF THE INVENTION

1. Field of the Invention

The present invention relates to an image input/output device, in particular with respect to a flexible image input/output device connecting with a first body and a second body by a flexible member.

2. Description of the Related Art

For the sake of technology is burgeoning, smart devices, such as smart phone and tablet and so on have been available to all in daily life; in the meanwhile, as the functions of the smart devices keep upgrading, demands for the related smart devices are increasing gradually.

As for as the smart devices' users are concerned, it is of convenience to use online communication, play games and deal with various tasks by smart phones, but in case things are tracked back to where it stated from, it can be found that the current smart devices only work when being held in one's hand, that is to say, the operative range is limited within user's hand, otherwise the practicability is disabled.

Furthermore, take an incoming call as an example, the user has to take it out of the handbag to answer the phone call whilst the smart device is placed in somewhere (e.g. in handbag). Consequently, in term of usage, it seems to cause certain inconvenience to the user.

As a result, how to overcome the aforementioned shortcomings of the known smart communication devices to promote the functions thereof is a task which the industry has to resolve.

### SUMMARY OF THE INVENTION

In view of the technical problems of the prior art, purpose of the present invention is to provide an image input/output device to solve the confronted shortcomings.

According to the purpose of the present invention, it may provide a flexible image input/output device comprising: a first body, a second body and a flexible member. The first body may have an image capture module, and the image capture module may generate a first image signal. The second body may separate from the first body and may have an image display module receiving the first image signal and displaying a fist image corresponding to the first image signal. The flexible member, of which one end may connect to the first body and another end may connect to the second body to transmit the first image signal from the image capture module to the image display module.

Preferably, the first and the second bodies may have a glasses frame connecting part respectively, the first body may be disposed at a side of the glasses frame by the glasses frame connecting part, and the second body, which is opposite to the first body, may be disposed at another side of the glasses frame by the glasses frame connecting part.

Preferably, the flexible image input/output device may electrically connect to an external device and the image capture module transmits the first image signal to the external device, or the external device may transmit a second image signal to the image display module for displaying.

Preferably, the flexible image input/output device may comprise a signal transmitter; the flexible image input/output device may electrically connect to the external device by the signal transmitter and conduct transmitting the first image signal or the second image signal via wire transmission by the signal transmitter.

Preferably, the external device may output a power to the flexible image input/output device by the signal transmitter.

Preferably, the flexible image input/output device may comprise a wireless transmission module; the flexible image input/output device may electrically connect to the external device by the wireless transmission module and conduct transmitting the first image signal or the second image signal via wireless transmission by the wireless transmission module.

Preferably, the flexible image input/output device may comprise an audio input/output module inputting or outputting an audio.

Preferably, the flexible image input/output device may comprise a triaxial accelerometer sensing triaxial acceleration of the flexible image input/output device to generate a control signal, and control the image capture module or the image display module according to the control signal.

Preferably, the flexible image input/output device may further comprise a power unit providing a power to the image capture module or the image display module for using.

Preferably, the image display module may be an prism module, a display screen module or a projection module.

In conclusion, by connecting the flexible member with the first and the second bodies, the flexible image input/output device of the present invention may flexibly apply the image input/output device to various spaces or to connect with the glasses frame so as to reduce the space limitation of the flexible image input/output device and thereby to enlarge the usage range and the image input/output device.

### BRIEF DESCRIPTION OF THE DRAWINGS

FIG. 1 is a block schematic diagram of the flexible image input/output device of the present invention.

FIG. 2 is a side view of the flexible image input/output device of the present invention.

FIG. 3 is a first schematic diagram of the flexible image input/output device of the present invention.

FIG. 4 is a second schematic diagram of the flexible image input/output device of the present invention.

FIG. 5 is a third schematic diagram of the flexible image input/output device of the present invention.

FIG. 6 is a fourth schematic diagram of the flexible image input/output device of the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

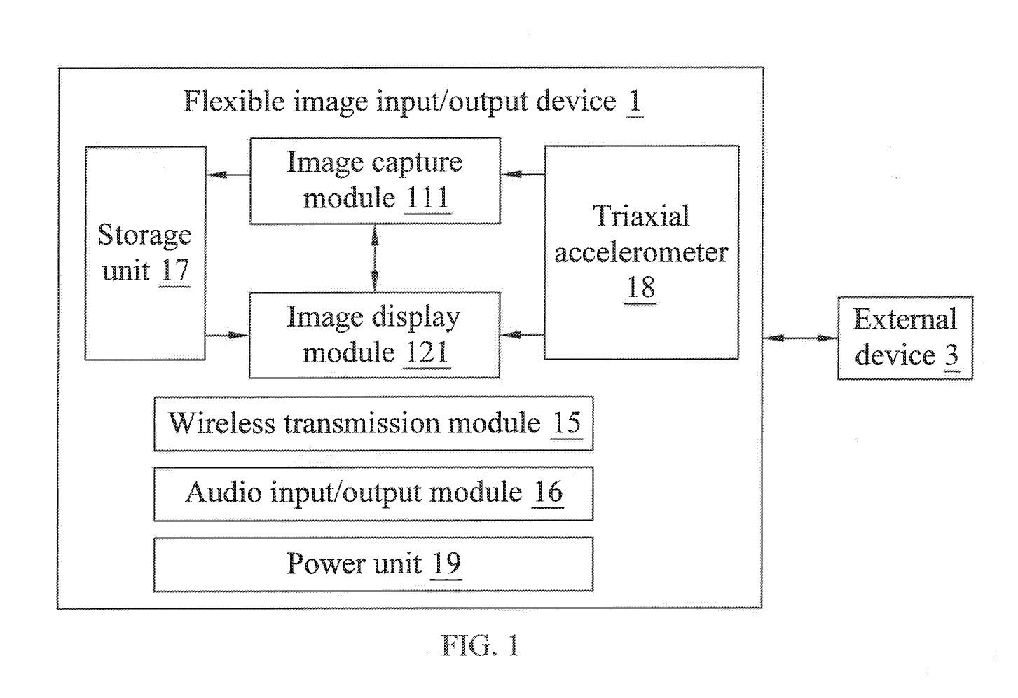

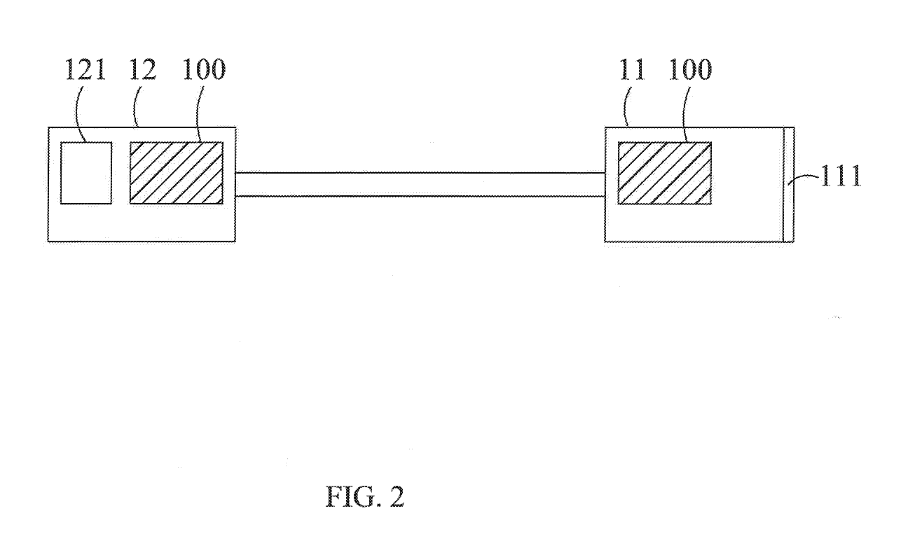

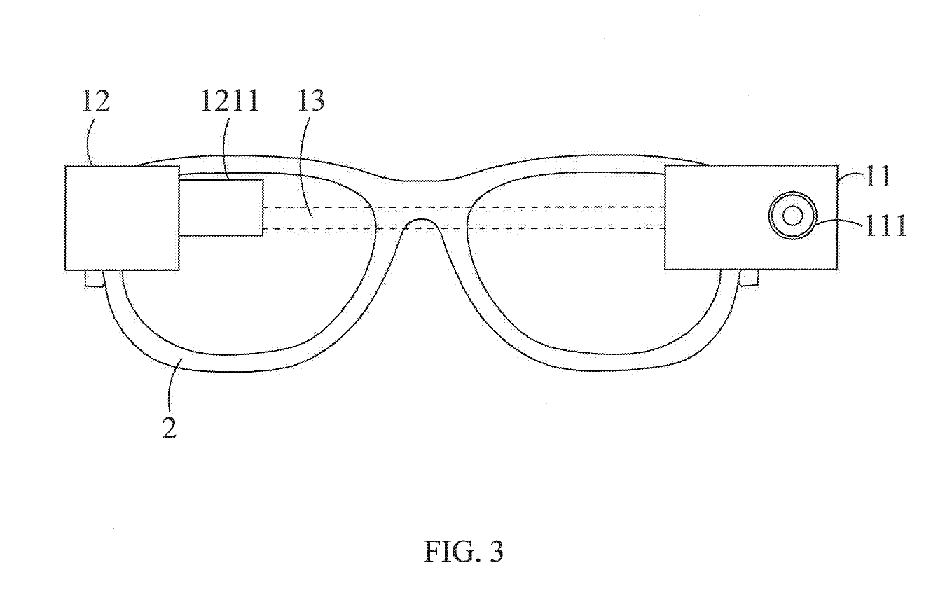

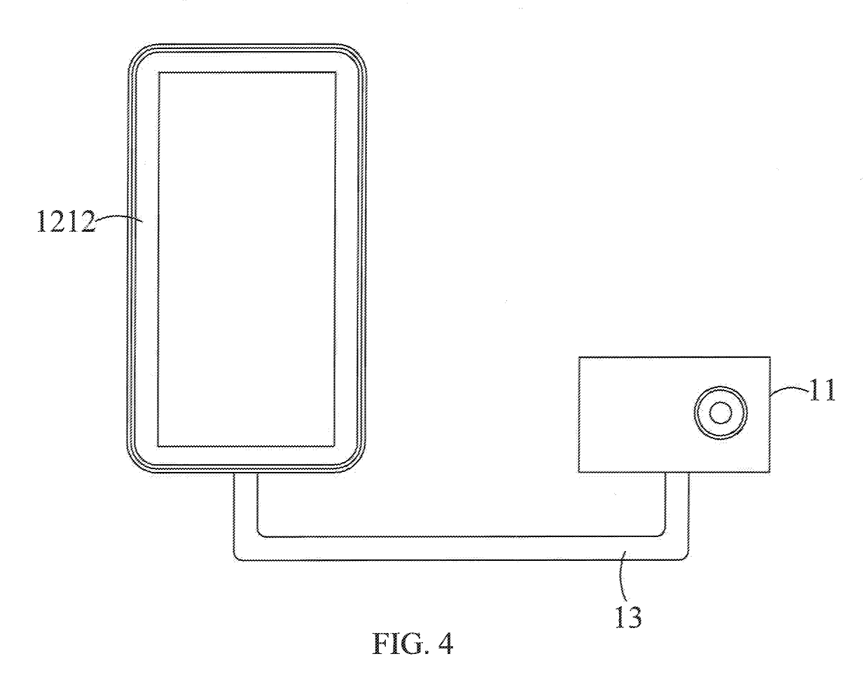

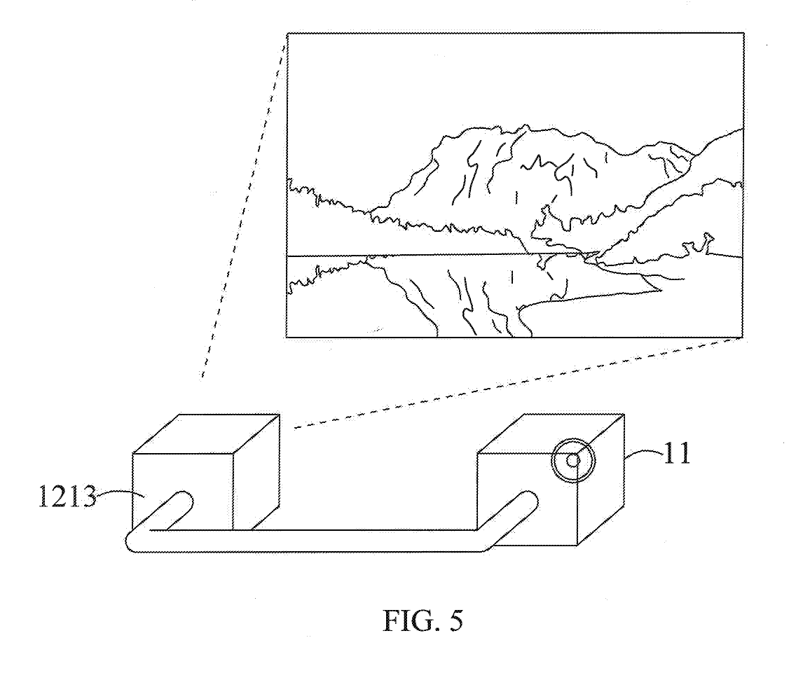

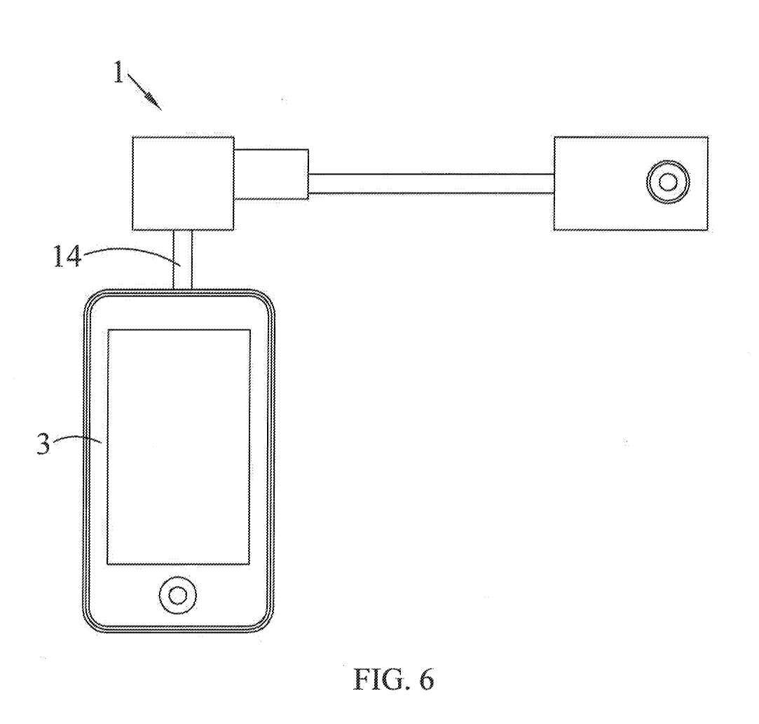

Please refer to FIG. 1 to FIG. 6; FIG. 1 is a block schematic diagram of the flexible image input/output device of the present invention, FIG. 2 is a side view of the flexible image input/output device of the present invention, FIG. 3 is a first schematic diagram of the flexible image input/output device of the present invention, FIG. 4 is a second schematic diagram of the flexible image input/output device of the present invention, FIG. 5 is a third schematic diagram of the flexible image input/output device of the present invention and FIG. 6 is a fourth schematic diagram of the flexible image input/output device of the present invention. As the FIGS. show, the flexible image input/output device of the present invention comprises a first body 11, a second body 12 and a flexible member 13. The first body 11 has an image capture module 111 generating a first image signal. The second body 12 separates from the first body and has an image display module 121 receiving the first image signal and displaying a first image corresponding to the first image signal. The flexible member 13, of which one end connects to the first body 11 and another end connects to the second body 12 to transmit the first image signal from the image capture module 111 to the image display module 121. Additionally, other than transmitting the first image single, the other data is transmitted between the image capture module 111 and the image display module 121 by the flexible member 13.

Furthermore, the image display module of the present invention is an prism module 1211, a display screen module 1212 or a projection module 1213, and is able to be adjusted according to the needs as well as the usage conditions. The following image display module 121 will take the prism module 1211, the display screen module 1212 or the projection module 1213 as examples to describe, respectively.

As FIG. 3 shows, when the image display module 121 is the prism module 1211, preferably, the first 11 and the second 12 bodies have a glasses frame connecting part 100 respectively, the first body is disposed at a side of the glasses frame 2 by the glasses frame connecting part 100, and the second body 12, which is opposite to the first body 11, is disposed at another side of the glasses frame 2 by the glasses frame connecting part 100; consequentially, when the user wears the glasses frame 2, the image watching is performed by the prism module 1211.

Here is a footnote that the glasses frame connecting part 100 takes a magnet as an example, the corresponding two sides of the glasses frame 2 have metal members, such that the glasses frame connecting part 100 solidly fixes the two sides of the glasses frame 2 by magnetic force; whereas, the preceding connection is only an example and shall not subject to this restriction.

And as FIG. 4 shows, when the image display module 121 is the display screen module 1212, it conducts the video watching just as phone screen or tablet screen does; furthermore, when the image capture module 111 conducts recording, the video picture is also available by the display screen module 1212, simultaneously.

Moreover, as FIG. 5 shows, when the image display module 121 is the projection module 1213, the user conducts video projection playing by hand-held mode or by placing the flexible image input/output device 1 on a platform; here, there is not restriction against the projection mode of the projection module 1213, it is set based on the function of the projection module 1213.

Subsequently, the flexible image input/output device 1 of the present invention is electrically connected to an external device 3, and the external device 3 is communication electronics devices (i.e. smart phone, tablet and so on) or storage devices (i.e. portable storage hard disc), so that the image capture module 111 transmits the first image signal which is generated by itself to the external device 3 for storing, or the external device 3 transmits the second image signal, which is generated by itself to the image display module 121 for displaying.

On the other hand, when the image capture module 111 is capturing image or recording, it transmits the first image signal to the image display module 121 to display the first image, and simultaneously, it transmits the first image signal to the external device 3 for storing; furthermore, before the first image signal is transmitted to the external device 3, the first image signal is transformed into an adequate file format and then is transmitted to the external device 3 so as to benefit from reading and watching through the external device 3.

Continuously, the flexible image input/output device 1 further comprises a signal transmitter 14; the flexible image input/output device 1 electrically connects to the external device 3 by the signal transmitter 14, and conducts transmitting the first image signal, the second image signal or the other data via wire transmission by the signal transmitter 14.

It is noteworthy that when the flexible image input/output device 1 connects to the external device 3 by the signal transmitter, the external device 3 outputs power to the flexible image input/output device 1 for using by the signal transmitter 14.

Additionally, the flexible image input/output device 1 also comprises a wireless transmission module 12 (i.e. Bluetooth module), the flexible image input/output device 1 electrically connects to the external device 3 by the wireless transmission module 15 and conducts transmitting the first image signal, the second image signal or the other data via wireless transmission by the wireless transmission module 15.

Owing to the normal films not only has image but also audio, the flexible image input/output device 1 the present invention has an audio input/output module 16 comprising elements such as headset, microphone and so on, such that inputting or outputting audio is conducted by the audio input/output module 16.

As the mentioned above, the image capture module 111 transmits the first image signal to the external device 3 for storing, and the external device 3 also transmits the second image signal to the image display module 121 to play; furthermore, the image input/output device 1 also comprises a storage unit 17 storing the first and the second image signals.

In addition, according to the preceding description, the external device 3 provides power to the image input/output device 1 by the signal transmitter 14, and the image input/output device 1 also comprises a power unit 19 (i.e. lithium battery) itself, so, when the image input/output device 1 does not connect to the external device 3, power is provided by the power unit 19 as well, so that the image capture module 111 and the image display module 121 operate normally.

It is noteworthy that the flexible image input/output device 1 of the present invention comprises a triaxial accelerometer 18, and as implied in the name, the triaxial accelerometer 18 is used to sense triaxial acceleration of the flexible image input/output device 1 to correspondingly generate a control signal, and control the actions of the image capture module 111 or the image display module 121 according to the control signal.

For example, when the flexible image input/output device 1 and a cell phone are electrically connected and disposed at user's glasses frame 2 simultaneously, in case someone calls, the user needn't to take out the cell phone to answer the incoming call but only “nodding” instinctively to respond; consequently, the triaxial accelerometer 18 senses the modification of triaxial acceleration of the flexible image input/output device 1 so as to correspondingly generate an “answer” control signal to switch on the incoming call and proceed to execute the call by the audio input/output module 16 of the flexible image input/output device 1.

In addition, in the process of shooting of the image capture module 111, similarly, it uses the simple head movement of the user to generate commands such as “start shooting” or “stop shooting” and so on to control the actions of the image capture module 111. However, the preceding operations are only taken as examples and can be adjusted based on the user's habit and needs, and shall not subject to this restriction.

Here is a footnote that the mentioned signal transmitter 14, the wireless communication module 15, the audio input/output module 16, the storage module 17, the triaxial accelerometer 18 and the power unit 19 are disposed or connected on the first 11 or the second 12 bodies, and shall not be restricted on the first 11 and the second 12 bodies only.

In conclusion, by replacing the image display module, the flexible image input/output device of the present invention is not only connected to the glasses frame, it can further greatly reduce the space limitation of the flexible image input/output device and thereby to enlarge the usage range and flexibility of the flexible image input/output device by the random bending characteristic of the flexible member.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A flexible image input/output device, comprising:
a first body having an image capture module, and the image capture module generating a first image signal;
a second body separating from the first body and having an image display module receiving the first image signal and displaying a fist image corresponding to the first image signal; and
a flexible member, of which one end connecting to the first body and another end connecting to the second body to transmit the first image signal from the image capture module to the image display module.

2. The flexible image input/output device of claim 1, wherein the first and the second bodies have a glasses frame connecting part respectively, the first body is disposed at a side of the glasses frame by the glasses frame connecting part, and the second body, which is opposite to the first body, is disposed at another side of the glasses frame by the glasses frame connecting part.

3. The flexible image input/output device of claim 1, wherein the flexible image input/output device electrically connects to an external device and the image capture module transmits the first image signal to the external device or the external device transmits a second image signal to the image display module for displaying.

4. The flexible image input/output device of claim 3, further comprising a signal transmitter, the flexible image input/output device electrically connecting to the external device by the signal transmitter, and conducting transmitting the first image signal or the second image signal via wire transmission by the signal transmitter.

5. The flexible image input/output device of claim 3, wherein the external device outputs a power to the flexible image input/output device by the signal transmitter.

6. The flexible image input/output device of claim 3, further comprising a wireless transmission module, the flexible image input/output device electrically connecting to the external device by the wireless transmission module and conducting transmitting the first image signal or the second image signal via wireless transmission by the wireless transmission module.

7. The flexible image input/output device of claim 3, further comprising an audio input/output module inputting or outputting an audio.

8. The flexible image input/output device of claim 1, further comprising a triaxial accelerometer sensing triaxial acceleration of the flexible image input/output device to generate a control signal, and controlling the image capture module or the image display module according to the control signal.

9. The flexible image input/output device of claim 1, further comprising a power unit providing a power to the image capture module or the image display module for using.

10. The flexible image input/output device of claim 1, wherein the image display module is an prism module, a display screen module or a projection module.
